(19) United States
(12) Patent Application Publication
(10) Pub. No.: US 2026/0074120 A1
(43) Pub. Date: Mar. 12, 2026

(54) MULTILAYER CERAMIC CAPACITOR

(71) Applicant: Murata Manufacturing Co., Ltd., Nagaokakyo-shi (JP)

(72) Inventors: Toshihiro KIMACHI, Nagaokakyo-shi (JP); Koshi IMAI, Nagaokakyo-shi (JP)

(21) Appl. No.: 19/302,469

(22) Filed: Aug. 18, 2025

(30) Foreign Application Priority Data
Sep. 10, 2024 (JP) 2024-156796

(51) Int. Cl. H01G 4/30; H01G 4/232

(52) U.S. Cl. CPC H01G 4/30; H01G 4/2325

(57) ABSTRACT

A multilayer ceramic capacitor includes a multilayer body including an inner layer portion and outer layer portions, and first and second external electrodes respectively including first and second base electrode layers and plating layers on the first and second base electrode layers. The first and second base electrode layers include metal, glass, and voids. Voids and glass in first and second outer layer portion-side base electrode layers have a lower space occupancy percentage than voids and glass in a first inner layer portion-side base electrode layer. Voids and glass in third and fourth outer layer portion-side base electrode layers have a lower space occupancy percentage than voids and glass in a second inner layer portion-side base electrode layer.

### CROSS-REFERENCE TO RELATED APPLICATION

This application claims the benefit of priority to Japanese Patent Application No. 2024-156796 filed on Sep. 10, 2024. The entire contents of this application are hereby incorporated herein by reference.

### BACKGROUND OF THE INVENTION

### 1. Field of the Invention

The present disclosure relates to multilayer ceramic capacitors.

### 2. Description of the Related Art

Japanese Unexamined Patent Application, Publication No. 2001-237137, for example, discloses a multilayer ceramic capacitor including a capacitor main body of a sintered ceramic body including a dielectric such as barium titanate. In the capacitor main body, internal electrode layers made of a noble metal material such as Ag or a Ag—Pd alloy or a base metal material such as Ni are arranged with ceramic layers (dielectric layers) interposed therebetween such that the internal electrode layers extend toward one end surface and the other end surface in an alternating manner. The internal electrode layers having one potential are electrically conductively connected to one external electrode, and the internal electrode layers having another potential are electrically conductively connected to the other external electrode.

In the multilayer ceramic capacitor according to Japanese Unexamined Patent Application, Publication No. 2001-237137, the internal electrode layers are made of a metal material, and the external electrodes are made of a glass component and a plurality of metal components including a metal identical to or capable of being alloyed with the metal material of the internal electrode layers. The multilayer ceramic capacitor is configured such that the external electrodes are bonded to a wiring board via a conductive resin adhesive, and the metal components have an area occupancy percentage of 60% to 95% with respect to a cross-sectional area of the external electrode, such that the multilayer ceramic capacitor can be mounted on the wiring board at low cost with high reliability without using solder.

However, a multilayer ceramic capacitor having a general structure, such as the multilayer ceramic capacitor of Japanese Unexamined Patent Application, Publication No. 2001-237137, has a disadvantage that the thickness of the external electrodes tends to be thin, and as a result, the moisture resistance deteriorates.

### SUMMARY OF THE INVENTION

Example embodiments of the present invention provide multilayer ceramic capacitors each able to ensure moisture resistance.

An example embodiment of the present invention provides a multilayer ceramic capacitor including a multilayer body including a plurality of dielectric layers and a plurality of internal electrode layers that are laminated, a first main surface and a second main surface opposed to each other in a height direction, a first side surface and a second side surface opposed to each other in a width direction that is orthogonal or substantially orthogonal to the height direction, a first end surface and a second end surface opposed to each other in a length direction that is orthogonal or substantially orthogonal to the height direction and the width direction, an inner layer portion in which the plurality of dielectric layers and the plurality of internal electrode layers are alternately laminated, and outer layer portions sandwiching the inner layer portion from a side of the first main surface and a side of the second main surface, a first external electrode including a first base electrode layer on the first end surface, and a plating layer on the first base electrode layer, and a second external electrode including a second base electrode layer on the second end surface, and a plating layer on the second base electrode layer. The first and second base electrode layers include metal, glass, and voids. The inner layer portion includes a first inner layer portion adjacent to the first end surface, and a second inner layer portion adjacent to the second end surface. The outer layer portions include a first outer layer portion adjacent to the first main surface and the first end surface, a second outer layer portion adjacent to the second main surface and the first end surface, a third outer layer portion adjacent to the first main surface and the second end surface, and a fourth outer layer portion adjacent to the second main surface and the second end surface. The first base electrode layer includes a first inner layer portion-side base electrode layer on the first inner layer portion, a first outer layer portion-side base electrode layer on the first outer layer portion, and a second outer layer portion-side base electrode layer on the second outer layer portion. The second base electrode layer includes a second inner layer portion-side base electrode layer on the second inner layer portion, a third outer layer portion-side base electrode layer on the third outer layer portion, and a fourth outer layer portion-side base electrode layer on the fourth outer layer portion. The voids in the first outer layer portion-side base electrode layer and the voids in the second outer layer portion-side base electrode layer have a lower space occupancy percentage than the voids in the first inner layer portion-side base electrode layer, and the glass in the first outer layer portion-side base electrode layer and the glass in the second outer layer portion-side base electrode layer have a lower space occupancy percentage than the glass in the first inner layer portion-side base electrode layer. The voids in the third outer layer portion-side base electrode layer and the voids in the fourth outer layer portion-side base electrode layer have a lower space occupancy percentage than the voids in the second inner layer portion-side base electrode layer, and the glass in the third outer layer portion-side base electrode layer and the glass in the fourth outer layer portion-side base electrode layer have a lower space occupancy percentage than the glass in the second inner layer portion-side base electrode layer. The space occupancy percentage of the voids in the first inner layer portion-side base electrode layer is about 11% or greater and about 16% or less, and the space occupancy percentage of the voids in the first outer layer portion-side base electrode layer and the space occupancy percentage of the voids in the second outer layer portion-side base electrode layer are each about 2% or greater and about 10% or less. The space occupancy percentage of the voids in the second inner layer portion-side base electrode layer is about 11% or greater and about 16% or less, and the space occupancy percentage of the voids in the third outer layer portion-side base electrode layer and the space occupancy percentage of the voids in the fourth outer layer portion-side base electrode layer are each about 2% or greater and about 10% or less. The space occupancy percentage of the glass in the first inner layer portion-side base electrode layer is about 8% or greater and about 11% or less, and the space occupancy percentage of the glass in the first outer layer portion-side base electrode layer and the space occupancy percentage of the glass in the second outer layer portion-side base electrode layer are each about 4.5% or greater and about 7.5% or less. The space occupancy percentage of the glass in the second inner layer portion-side base electrode layer is about 8% or greater and about 11% or less, and the space occupancy percentage of the glass in the third outer layer portion-side base electrode layer and the space occupancy percentage of the glass in the fourth outer layer portion-side base electrode layer are each about 4.5% or greater and about 7.5% or less.

The multilayer ceramic capacitor according to the above-described example embodiment of the present invention ensures moisture resistance due to the configuration in which the outer layer portion-side base electrode layers have a low space occupancy percentage of the voids, a low space occupancy percentage of glass, and a high film density.

Another example embodiment of the present invention provides a multilayer ceramic capacitor including a multilayer body including a plurality of dielectric layers and a plurality of internal electrode layers that are laminated, a first main surface and a second main surface opposed to each other in a height direction, a first side surface and a second side surface opposed to each other in a width direction that is orthogonal or substantially orthogonal to the height direction, a first end surface and a second end surface opposed to each other in a length direction that is orthogonal or substantially orthogonal to the height direction and the width direction, an inner layer portion in which the plurality of dielectric layers and the plurality of internal electrode layers are alternately laminated, and outer layer portions sandwiching the inner layer portion from a side of the first main surface and a side of the second main surface, a first external electrode including a first base electrode layer on the first end surface, and a plating layer on the first base electrode layer, and a second external electrode including a second base electrode layer on the second end surface, and a plating layer on the second base electrode layer. The first and second base electrode layers include metal, glass, and voids. The inner layer portion includes a first inner layer portion adjacent to the first end surface, and a second inner layer portion adjacent to the second end surface. The outer layer portions include a first outer layer portion adjacent to the first main surface and the first end surface, a second outer layer portion adjacent to the second main surface and the first end surface, a third outer layer portion adjacent to the first main surface and the second end surface, and a fourth outer layer portion adjacent to the second main surface and the second end surface. The first base electrode layer includes a first inner layer portion-side base electrode layer on the first inner layer portion, a first outer layer portion-side base electrode layer on the first outer layer portion, and a second outer layer portion-side base electrode layer on the second outer layer portion. The second base electrode layer includes a second inner layer portion-side base electrode layer on the second inner layer portion, a third outer layer portion-side base electrode layer on the third outer layer portion, and a fourth outer layer portion-side base electrode layer on the fourth outer layer portion. The first outer layer portion-side base electrode layer includes a first end-surface-side region adjacent to the first end surface, and a first main-surface-side region adjacent to the first main surface. The second outer layer portion-side base electrode layer includes a second end-surface-side region adjacent to the first end surface, and a second main-surface-side region adjacent to the second main surface. The third outer layer portion-side base electrode layer includes a third end-surface-side region adjacent to the second end surface, and a third main-surface-side region adjacent to the first main surface. The fourth outer layer portion-side base electrode layer includes a fourth end-surface-side region adjacent to the second end surface, and a fourth main-surface-side region adjacent to the second main surface. The glass in the first main-surface-side region has a lower space occupancy percentage than the glass in the first end-surface-side region. The glass in the second main-surface-side region has a lower space occupancy percentage than the glass in the second end-surface-side region. The glass in the third main-surface-side region has a lower space occupancy percentage than the glass in the third end-surface-side region. The glass in the fourth main-surface-side region has a lower space occupancy percentage than the glass in the fourth end-surface-side region. The space occupancy percentage of the glass in the first main-surface-side region and the space occupancy percentage of the glass in the third main-surface-side region are each about 5% or greater and about 8% or less. The space occupancy percentage of the glass in the first end-surface-side region and the space occupancy percentage of the glass in the second end-surface-side region are each about 9% or greater and about 18% or less. The space occupancy percentage of the glass in the second main-surface-side region and the space occupancy percentage of the glass in the fourth main-surface-side region are each about 5% or greater and about 8% or less. The space occupancy percentage of the glass in the third end-surface-side region and the space occupancy percentage of the glass in the fourth end-surface-side region are each about 9% or greater and about 18% or less.

The multilayer ceramic capacitors according to the above-described example embodiments of the present invention ensure moisture resistance as a result of the configurations in which the outer layer portion-side base electrode layers have a further increased film density.

Example embodiments of the present invention provide multilayer ceramic capacitors each able to ensure moisture resistance due to a configuration in which outer layer portion-side base electrode layers have a low space occupancy percentage of voids, a low space occupancy percentage of glass, and a high film density.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating one example of a multilayer ceramic capacitor according to an example embodiment of the present invention.

FIG. 2 is a front view illustrating one example of a multilayer ceramic capacitor according to an example embodiment of the present invention.

FIG. 3 is a plan view illustrating one example of a multilayer ceramic capacitor according to an example embodiment of the present invention.

FIG. 4 is a schematic cross-sectional view taken along line IV-IV in FIG. 3.

FIG. 5 is a schematic cross-sectional view taken along line V-V in FIG. 3.

FIG. 6 is a schematic cross-sectional view taken along line VI-VI in FIG. 4.

FIG. 7A is a cross-sectional view illustrating a structure in which a counter electrode portion of an internal electrode layer of a multilayer ceramic capacitor according to an example embodiment of the present invention is divided into two.

FIG. 7B is a cross-sectional view illustrating a structure in which a counter electrode portion of an internal electrode layer of a multilayer ceramic capacitor according to the present invention is divided into three.

FIG. 7C is a cross-sectional view illustrating a structure in which a counter electrode portion of an internal electrode layer of a multilayer ceramic capacitor according to the present invention is divided into four.

### DETAILED DESCRIPTION OF THE EXAMPLE EMBODIMENTS

Examples of multilayer ceramic capacitors according to example embodiments of the present invention will be described below with reference to the drawings.

### 1. Multilayer Ceramic Capacitor

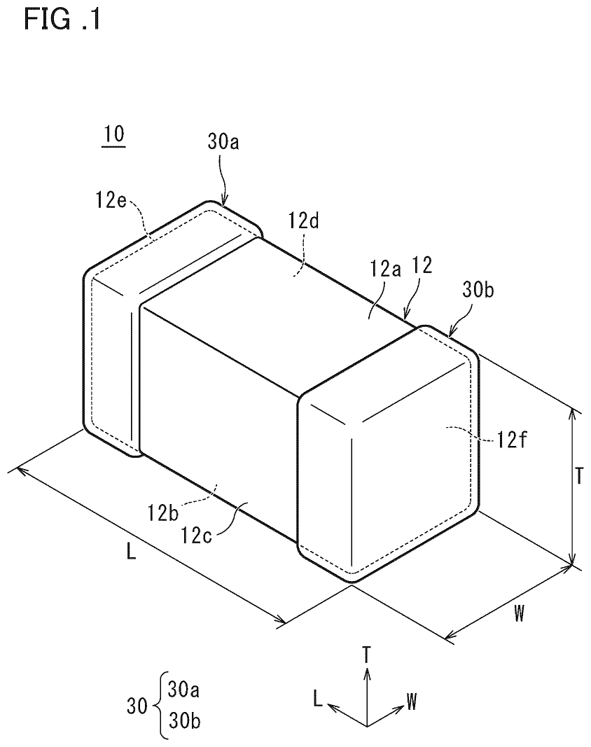

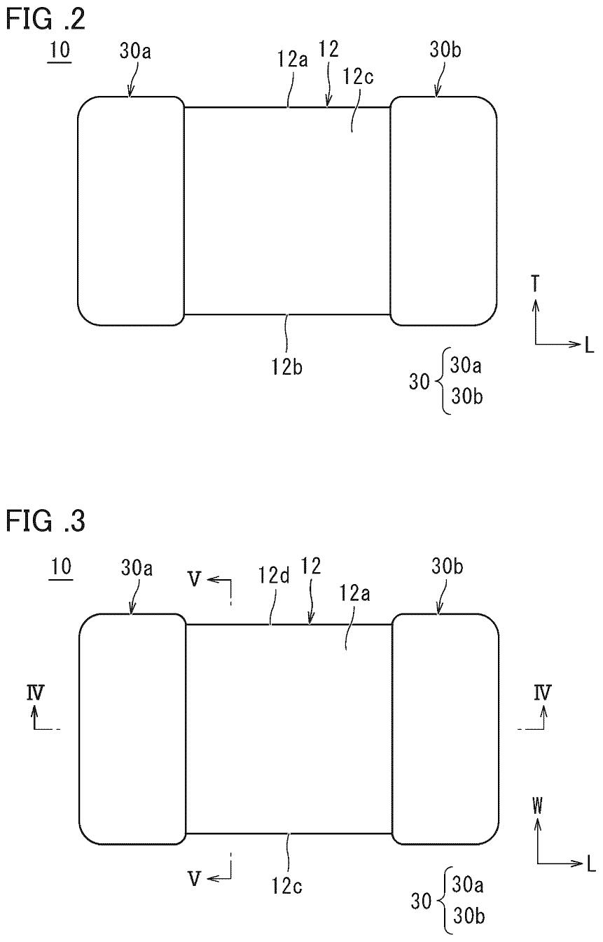

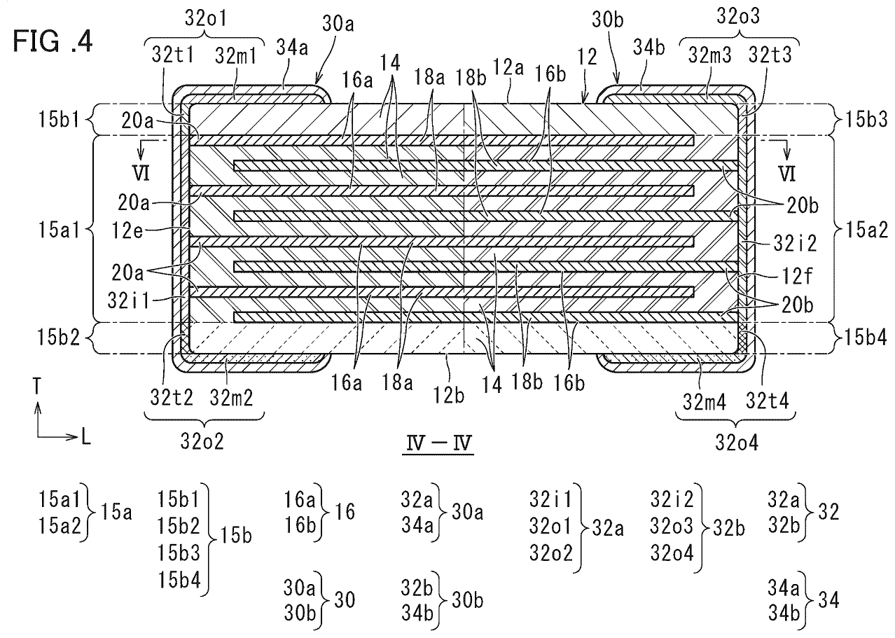

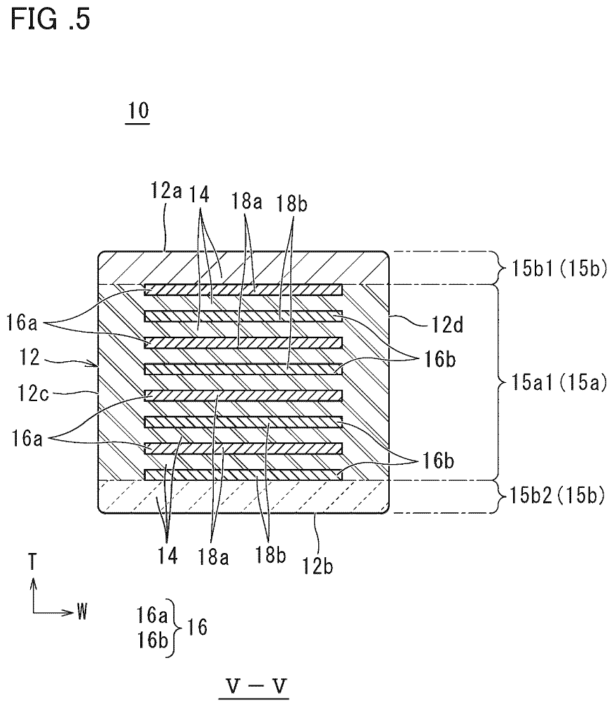

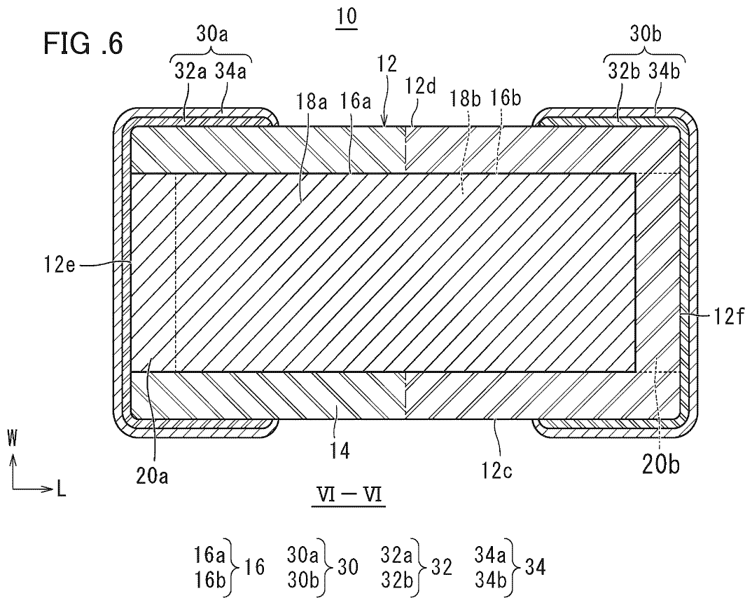

The following describes one example of a multilayer ceramic capacitor according to an example embodiment of the present invention. FIG. 1 is an external perspective view illustrating the one example of the multilayer ceramic capacitor according to the present example embodiment of the present invention. FIG. 2 is a front view illustrating the one example of the multilayer ceramic capacitor according to the present example embodiment of the present invention. FIG. 3 is a plan view illustrating the one example of the multilayer ceramic capacitor according to the present example embodiment of the present invention. FIG. 4 is a schematic cross-sectional view taken along line IV-IV in FIG. 3. FIG. 5 is a schematic cross-sectional view taken along line V-V in FIG. 3. FIG. 6 is a schematic cross-sectional view taken along line VI-VI in FIG. 4.

The multilayer ceramic capacitor 10 includes a multilayer body 12 and external electrodes 30. The multilayer body 12 includes an inner layer portion 15a in which a plurality of dielectric layers 14 and a plurality of internal electrode layers 16 are alternately laminated and which produces capacitance, and outer layer portions 15b sandwiching the inner layer portion 15a from upper and lower main surfaces.

Hereinafter, the configurations of the multilayer body 12, the internal electrode layers 16, and the external electrodes 30 will be described in this order.

### Multilayer Body

The multilayer body 12 includes the plurality of dielectric layers 14 and the plurality of internal electrode layers 16 that are laminated. The multilayer body 12 includes a first main surface 12a and a second main surface 12b opposed to each other in a height direction T that is the lamination direction in which the plurality of dielectric layers 14 are laminated, a first side surface 12c and a second side surface 12d opposed to each other in a width direction W that is orthogonal or substantially orthogonal to the height direction T, and a first end surface 12e and a second end surface 12f opposed to each other in a length direction L that is orthogonal or substantially orthogonal to the height direction T and the width direction W. The length direction L is defined as the L direction connecting the first end surface 12e and the second end surface 12f. The width direction W is defined as the W direction connecting the first side surface 12c and the second side surface 12d. The height direction T is defined as the T direction connecting the first main surface 12a and the second main surface 12b.

The multilayer body a rectangular or 12 has substantially rectangular parallelepiped shape. The multilayer body 12 may have rounded corner portions and rounded ridge portions. That is, the “rectangular or substantially rectangular parallelepiped shape” as used herein includes a rectangular or substantially rectangular parallelepiped with rounded corner portions and/or rounded ridge portions. In other words, a structure having a “rectangular or substantially rectangular parallelepiped shape” means a general structure including the first main surface 12a and the second main surface 12b, the first side surface 12c and the second side surface 12d, and the first end surface 12e and the second end surface 12f. The corner portion is where three adjacent surfaces of the multilayer body 12 intersect meet, and the ridge portion is where two adjacent surfaces of the multilayer body 12 meet.

The first main surface 12a and the second main surface 12b, the first side surface 12c and the second side surface 12d, and the first end surface 12e and the second end surface 12f may each include irregularities or the like in a portion or the entirety thereof.

In the multilayer body 12, a plurality of first internal electrode layers 16a and second internal electrode layers 16b (to having a rectangular or substantially be described later) are or rectangular shape alternately arranged at equal substantially equal intervals in the height direction T. Each of the first internal electrode layers 16a and the second internal electrode layers 16b is parallel or substantially parallel to the first main surface 12a and the second main surface 12b. The first internal electrode layer 16a and the second internal electrode layer 16b face each other with the dielectric layer 14 interposed therebetween in the height direction T.

As illustrated in FIGS. 4 and 5, the multilayer body 12 includes the inner layer portion 15a in which the plurality of internal electrode layers 16 face each other in the height direction T connecting the first main surface 12a and the second main surface 12b to each other, and the outer layer portions 15b respectively including a plurality of dielectric layers 14 disposed between the first main surface 12a and the internal electrode layer 16 closest to the first main surface 12a and a plurality of dielectric layers 14 disposed between the second main surface 12b and the internal electrode layer 16 closest to the second main surface 12b.

As illustrated in FIG. 4, the inner layer portion 15a includes a first inner layer portion 15al adjacent to the first end surface 12e and a second inner layer portion 15a2 adjacent to the second end surface 12f side.

The outer layer portions 15b include a first outer layer portion 15b1, a second outer layer portion 15b2, a third outer layer portion 15b3, and a fourth outer layer portion 15b4.

The first outer layer portion 15b1 is adjacent to the first main surface 12a and the first end surface 12e of the multilayer body 12. The first outer layer portion 15b1 is an aggregate of two or more dielectric layers 14 disposed between the first main surface 12a and the internal electrode layer 16 closest to the first main surface 12a.

The second outer layer portion 15b2 is adjacent to the second main surface 12b and the first end surface 12e of the multilayer body 12. The second outer layer portion 15b2 is an aggregate of two or more dielectric layers 14 disposed between the second main surface 12b and the internal electrode layer 16 closest to the second main surface 12b.

The third outer layer portion 15b3 is adjacent to the first main surface 12a and the second end surface 12f of the multilayer body 12. The third outer layer portion 15b3 is an aggregate of the two or more dielectric layers 14 disposed between the first main surface 12a and the internal electrode layer 16 closest to the first main surface 12a.

The fourth outer layer portion 15b4 is adjacent to the second main surface 12b and the second end surface 12f of the multilayer body 12. The fourth outer layer portion 15b4 is an aggregate of the two or more dielectric layers 14 disposed between the second main surface 12b and the internal electrode layer 16 closest to the second main surface 12b.

The region sandwiched between the first outer layer portion 15b1 and the second outer layer portion 15b2 is the first inner layer portion 15a1. The region sandwiched between the third outer layer portion 15b3 and the fourth outer layer portion 15b4 is the second inner layer portion 15a2.

Each dielectric layer 14 preferably has a thickness of, for example, about 0.5 μm or greater and about 10 μm or less.

As a ceramic material used for the dielectric layer 14, for example, a dielectric ceramic including BaTiO₃, CaTiO₃, SrTiO₃, CaZrO₃ or the like as a main component can be used. Furthermore, for example, a subcomponent such as a Mn compound, a Fe compound, a Cr compound, a Co compound, or a Ni compound, may be added in lower amount than the main component, in accordance with the desired characteristics of the multilayer body.

### Internal Electrode Layer

As illustrated in FIGS. 4 and 5, the internal electrode layers 16 include the first internal electrode layers 16a and the second internal electrode layers 16b. The first internal electrode layers 16a and the second internal electrode layers 16b are alternately laminated with the dielectric layers 14 interposed therebetween.

The first internal electrode layers 16a are disposed on surfaces of the dielectric layers 14. Each first internal electrode layer 16a includes a first counter electrode portion 18a and a first extension electrode portion 20a. The first counter electrode portion 18a faces the second internal electrode layer 16b. The first extension electrode portion 20a is located in one end portion of the first internal electrode layer 16a and extends to the first end surface 12e of the multilayer body 12 from the first counter electrode portion 18a. The first extension electrode portion 20a includes an end extending toward the first end surface 12e and exposed. Specifically, the end of the first extension electrode portion 20a is located slightly inward with respect to the first end surface 12e. The first extension electrode portion 20a is not exposed at the first main surface 12a, the second main surface 12b, the first side surface 12c, or the second side surface 12d.

The second internal electrode layers 16b are disposed on surfaces of the dielectric layers 14 that are different from the dielectric layers 14 on which the first internal electrode layers 16a are disposed. Each second internal electrode layer 16b includes a second counter electrode portion 18b and a second extension electrode portion 20b. The second counter electrode portion 18b faces the first internal electrode layer 16a. The second extension electrode portion 20b is located in one end portion of the second internal electrode layer 16b and extends to the second end surface 12f of the multilayer body 12 from the second counter electrode portion 18b. The second extension electrode portion 20b includes an end extending toward the second end surface 12f and exposed. Specifically, the end of the second extension electrode portion 20b is located slightly inward with respect to the second end surface 12f. The second extension electrode portion 20b is not exposed at the first main surface 12a, the second main surface 12b, the first side surface 12c, or the second side surface 12d.

The internal electrode layers 16 can include an appropriate conductive material, and examples thereof include metals such as Ni, Cu, Ag, Pd, Au, etc., or an alloy including at least one of these metals, such as a Ag—Pd alloy. The metal of the internal electrode layers 16 forms a compound with a metal forming a conductive filler included in a conductive resin layer (to be described later) of the external electrodes 30.

Each of the first internal electrode layers 16a and the second internal electrode layers 16b preferably has a thickness of, for example, about 0.2 μm or greater and about 2.0 μm or less.

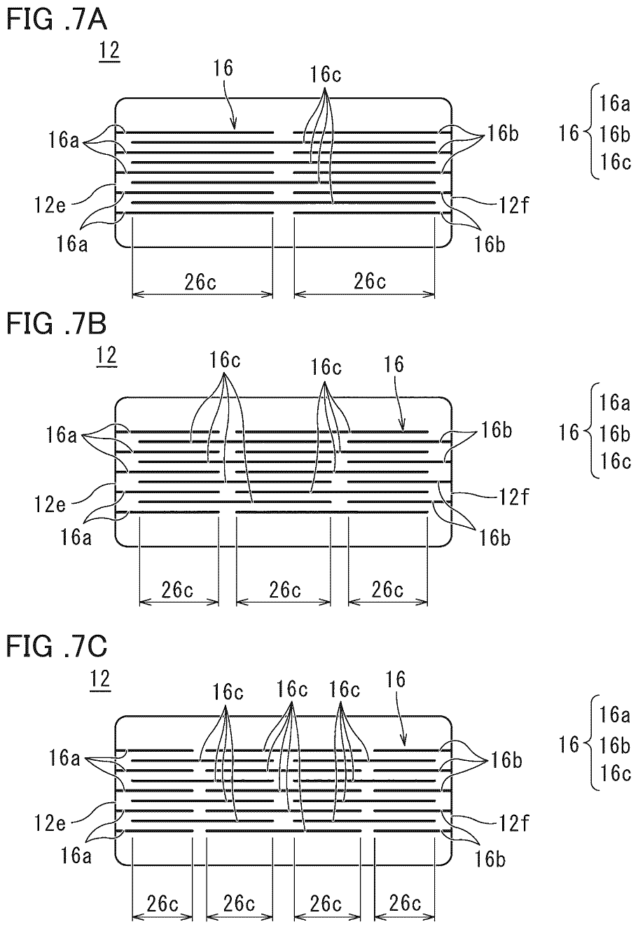

As illustrated in FIGS. 7A to 7C, the multilayer body 12 may have a structure in which floating internal electrode layers 16c not extending toward either the first end surface 12e or the second end surface 12f are arranged in addition to the first internal electrode layers 16a and the second internal electrode layers 16b, and in which a counter electrode portion 26c is divided into two or more segments due to the floating internal electrode layers 16c. For example, the multilayer body may have a two-segment structure as illustrated in FIG. 7A, a three-segment structure as illustrated in FIG. 7B, or a four-segment structure illustrated in FIG. 7C, and it may have a four or more-segment structure. By using the structure in which the counter electrode portion 26c is divided into two or more segments, a plurality of capacitor components are provided between the first internal electrode layers 16a, the second internal electrode layers 16b, and the floating internal electrode layers 16c that face each other, and these capacitor components are connected in series. As a result, a low voltage is applied to each of the capacitor components, thus enabling the multilayer ceramic capacitor 10 to have a high breakdown voltage.

Similarly to the first internal electrode layers 16a and the second internal electrode layers 16b, the floating internal electrode layers 16c can include, for example, an appropriate conductive material, examples of which include metals such as Ni, Cu, Ag, Pd, Au, etc., or an alloy including at least one of these metals such as a Ag—Pd alloy.

### External Electrode

As illustrated in FIGS. 1 to 3, the external electrodes 30 are disposed on the first end surface 12e and the second end surface 12f of the multilayer body 12.

Each external electrode 30 includes a base electrode layer 32 including a metal component and glass, and preferably includes a plating layer 34 disposed on a surface of the base electrode layer 32.

The external electrodes 30 include a first external electrode 30a and a second external electrode 30b.

The first external electrode 30a is connected to the first internal electrode layers 16a, and is disposed on at least the surface of the first end surface 12e. The first external electrode 30a may extend from the first end surface 12e of the multilayer body 12 to a portion of the first main surface 12a, a portion of the second main surface 12b, a portion of the first side surface 12c, and a portion of the second side surface 12d. In the present example embodiment, the first external electrode 30a extends from the first end surface 12e to a portion of the first main surface 12a, a portion of the second main surface 12b, a portion of the first side surface 12c, and a portion of the second side surface 12d. The first external electrode 30a is electrically connected to the first extension electrode portions 20a of the first internal electrode layers 16a.

The first external electrode 30a includes a first base electrode layer 32a disposed on the first end surface 12e, and preferably includes a first upper plating layer 34a disposed on the first base electrode layer 32a.

The second external electrode 30b is connected to the second internal electrode layers 16b, and is disposed on at least the surface of the second end surface 12f. The second external electrode 30b may extend from the second end surface 12f of the multilayer body 12 to a portion of the first main surface 12a, a portion of the second main surface 12b, a portion of the first side surface 12c, and a portion of the second side surface 12d. In the present example embodiment, the second external electrode 30b extends from the second end surface 12f to a portion of the first main surface 12a, a portion of the second main surface 12b, a portion of the first side surface 12c, and a portion of the second side surface 12d. The second external electrode 30b is electrically connected to the second extension electrode portions 20b of the second internal electrode layers 16b.

The second external electrode 30b includes a second base electrode layer 32b disposed on the second end surface 12f, and preferably includes a second upper plating layer 34b disposed on the second base electrode layer 32b.

In the multilayer body 12, the first counter electrode portions 18a of the first internal electrode layers 16a and the second counter electrode portions 18b of the second internal electrode layers 16b face each other with the dielectric layers 14 interposed therebetween, thus generating capacitance. As a result, capacitance can be obtained between the first external electrode 30a to which the first internal electrode layers 16a are connected and the second external electrode 30b to which the second internal electrode layers 16b are connected, such that the characteristics of the capacitor are provided.

The base electrode layer 32 includes the first base electrode layer 32a and the second base electrode layer 32b.

The first base electrode layer 32a is connected to the first internal electrode layers 16a and is disposed on the surface of the first end surface 12e. The first base electrode layer 32a extends from the first end surface 12e to a portion of the first main surface 12a, a portion of the second main surface 12b, a portion of the first side surface 12c, and a portion of the second side surface 12d. In this case, the first base electrode layer 32a is electrically connected to the first extension electrode portions 20a of the first internal electrode layers 16a.

The first base electrode layer 32a and the second base electrode layer 32b include a metal, glass, and voids.

As illustrated in FIG. 4, the first base electrode layer 32a includes a first inner layer portion-side base electrode layer 32i1 disposed on the first inner layer portion 15a1, a first outer layer portion-side base electrode layer 32o1 disposed on the first outer layer portion 15b1, and a second outer layer portion-side base electrode layer 32o2 disposed on the second outer layer portion 15b2.

The first outer layer portion-side base electrode layer 32o1 includes a first end-surface-side region 32t1 disposed adjacent to the first end surface 12e and a first main-surface-side region 32m1 disposed adjacent to the first main surface 12a.

The second outer layer portion-side base electrode layer 32o2 includes a second end-surface-side region 32t2 disposed adjacent to the first end surface 12e and a second main-surface-side region 32m2 disposed adjacent to the second main surface 12b.

The second base electrode layer 32b is connected to the second internal electrode layers 16b and is disposed on the surface of the second end surface 12f. The second base electrode layer 32b extends from the second end surface 12f to be also disposed on a portion of the first main surface 12a, a portion of the second main surface 12b, a portion of the first side surface 12c, and a portion of the second side surface 12d. In this case, the second base electrode layer 32b is electrically connected to the second extension electrode portions 20b of the second internal electrode layers 16b.

As illustrated in FIG. 4, the second base electrode layer 32b includes a second inner layer portion-side base electrode layer 32i2 disposed on the second inner layer portion 15a2, a third outer layer portion-side base electrode layer 32o3 disposed on the third outer layer portion 15b3, and a fourth outer layer portion-side base electrode layer 32o4 disposed on the fourth outer layer portion 15b4.

The third outer layer portion-side base electrode layer 32o3 includes a third end-surface-side region 32t3 disposed adjacent to the second end surface 12f and a third main-surface-side region 32m3 disposed adjacent to the first main surface 12a.

The fourth outer layer portion-side base electrode layer 32o4 includes a fourth end-surface-side region 32t4 disposed adjacent to the second end surface 12f and a fourth main-surface-side region 32m4 disposed adjacent to the second main surface 12b.

The voids in the first outer layer portion-side base electrode layer 32o1 and the voids in the second outer layer portion-side base electrode layer 32o2 have a lower space occupancy percentage than the voids in the first inner layer portion-side base electrode layer 32i1.

The glass in the first outer layer portion-side base electrode layer 32o1 and the glass in the second outer layer portion-side base electrode layer 32o2 have a lower space occupancy percentage than the glass in the first inner layer portion-side base electrode layer 32i1.

The voids in the third outer layer portion-side base electrode layer 32o3 and the voids in the fourth outer layer portion-side base electrode layer 32o4 have a lower space occupancy percentage than the voids in the second inner layer portion-side base electrode layer 32i2.

The glass in the third outer layer portion-side base electrode layer 32o3 and the glass in the fourth outer layer portion-side base electrode layer 32o4 have a lower space occupancy percentage than the glass in the second inner layer portion-side base electrode layer 32i2.

The specifics are as follows.

The space occupancy percentage of the voids in the first inner layer portion-side base electrode layer 32i1 is, for example, about 11% or greater and about 16% or less.

The space occupancy percentage of the voids in the second inner layer portion-side base electrode layer 32i2 is, for example, about 11% or greater and about 16% or less.

The space occupancy percentage of the voids in the first outer layer portion-side base electrode layer 32o1 and the space occupancy percentage of the voids in the second outer layer portion-side base electrode layer 32o2 are each, for example, about 2% or greater and about 10% or less.

The space occupancy percentage of the voids in the third outer layer portion-side base electrode layer 32o3 and the space occupancy percentage of the voids in the fourth outer layer portion-side base electrode layer 32o4 are each, for example, about 2% or greater and about 10% or less.

The space occupancy percentage of the glass in the first inner layer portion-side base electrode layer 32i1 is, for example, about 8% or greater and about 11% or less.

The space occupancy percentage of the glass in the second inner layer portion-side base electrode layer 32i2 is, for example, about 8% or greater and about 11% or less.

The space occupancy percentage of the glass in the first outer layer portion-side base electrode layer 32o1 and the space occupancy percentage of the glass in second outer layer portion-side base electrode layer 32o2 are each, for example, about 4.5% or greater and about 7.5% or less.

The space occupancy percentage of the glass in the third outer layer portion-side base electrode layer 32o3 and the space occupancy percentage of the glass in the fourth outer layer portion-side base electrode layer 32o4 are each, for example, about 4.5% or greater and about 7.5% or less.

In general, each external electrode 30 tends to have a small film thickness in a portion on the outer layer portion 15b, and as a result, moisture resistance deteriorates. To address this, the above-described configuration is provided, in which the space occupancy percentage of the voids and the space occupancy percentage of the glass in the portion of each external electrode 30 on the outer layer portion 15b are lowered so that the film density of the portion of the external electrode 30 on the outer layer portion 15b is increased. As a result, the moisture resistance can be ensured.

Furthermore, in the first outer layer portion-side base electrode layer 32o1, the space occupancy percentage of the glass included in the first main-surface-side region 32m1 is lower than that of the glass included in the first end-surface-side region 32t1.

In the second outer layer portion-side base electrode layer 32o2, the space occupancy percentage of the glass included in the second main-surface-side region 32m2 is lower than that of the glass included in the second end-surface-side region 32t2.

In the third outer layer portion-side base electrode layer 32o3, the space occupancy percentage of the glass included in the third main-surface-side region 32m3 is lower than that of the glass included in the third end-surface-side region 32t3.

In the fourth outer layer portion-side base electrode layer 32o4, the space occupancy percentage of the glass included in the fourth main-surface-side region 32m4 is lower than that of the glass included in the fourth end-surface-side region 32t4. The specifics are as follows.

The space occupancy percentage of the glass included in the first main-surface-side region 32m1 and that of the glass included in the third main-surface-side region 32m3 are each, for example, about 5% or greater and about 8% or less.

The space occupancy percentage of the glass included in the first end-surface-side region 32t1 and that of the glass included in the second end-surface-side region 32t2 are each, for example, about 9% or greater and about 18% or less.

The space occupancy percentage of the glass included in the second main-surface-side region 32m2 and that of the glass included in the fourth main-surface-side region 32m4 are each, for example, about 5% or greater and about 8% or less.

The space occupancy percentage of the glass included in the third end-surface-side region 32t3 and that of the glass included in the fourth end-surface-side region 32t4 are each, for example, about 9% or greater and about 18% or less.

Due to the above-described configuration, the film density of the portion of each external electrode 30 on the outer layer portion 15b is further increased, thus ensuring the moisture resistance.

The above-described space occupancy percentage of the voids is measured in the following manner, for example. A scanning electron microscope (SEM) is used to obtain a SEM image of an LT cross section so that the space occupancy percentage of the voids is calculated. The SEM image is obtained as, for example, a backscattered electron image (with electrification reduction), and brightened at about 15 kV until the voids are recognized in the SEM image. The magnification of the image is about 1200 times for the interior of the base electrode layer 32, and about 1000 times for the surface of the base electrode layer 32. For the interior of the base electrode layer 32, the magnification is about 1200 times, and the resolution is about 512×416 pixels. The image at this time has a lateral width of about 125.5 μm. For the surface of the base electrode layer 32, the magnification is about 1000 times, and the resolution is about 512×416 pixels. The image at this time has a lateral width of about 150.6 μm. Then, the obtained SEM image is binarized into the voids and a region other than the voids by using, for example, Image-J. Then, a ratio of an area of the voids is measured using the binarized data, and the measured ratio is defined as the space occupancy percentage of the voids.

The space occupancy percentage of the glass is measured in the following manner, for example. A scanning electron microscope (SEM) is used to obtain a SEM image of an LT cross section so that the space occupancy percentage of the glass is calculated. The conditions for obtaining the SEM image are the same or substantially the same as in the case of calculating the space occupancy percentage of the voids. In a mapping analysis image by EDX analysis, portions corresponding to Si elements are displayed in white, and the image is saved. Subsequently, the region with the Si elements and the other region are binarized using Image-J. Then, a ratio of an area of the glass is measured using the binarized data, and the measured ratio is defined as the space occupancy percentage of the glass.

The base electrode layer 32 includes, for example, at least one of a baked layer, a conductive resin layer, a thin film layer, or the like.

The following describes the case where the base electrode layer 32 is the baked layer and the case where the base electrode layer 32 is the conductive resin layer.

In the case of the baked layer, the baked layer includes a metal component and glass. The metal component of the baked layer includes, for example, at least one of Cu, Ni, Ag, Pd, a Ag—Pd alloy, Au, or the like. The baked layer may include a plurality of layers. The baked layer is formed by applying a conductive paste including glass and the metal to multilayer body, and baking the applied paste. The baked layer is formed by firing a multilayer chip including the internal electrode layers 16 and the dielectric layers 14 concurrently with the conductive paste applied to the multilayer chip. Alternatively, the baked layer may be formed by baking after the firing of the multilayer chip including the internal electrode layers 16 and the dielectric layers 14.

Preferably, the first base electrode layer 32a on the first end surface 12e has, in its central portion in the height direction T, a thickness of, for example, about 10 μm or greater and about 150 μm or less in the length direction L.

Preferably, the second base electrode layer 32b on the second end surface 12f has, in its central portion in the height direction T, a thickness of, for example, about 10 μm or greater and about 150 μm or less in the length direction L.

In a case where the base electrode layer 32 is disposed on the first main surface 12a, the second main surface 12b, the first side surface 12c, and the second side surface 12d, the first base electrode layer 32a on a portion of the first main surface 12a and a portion of the second main surface 12b preferably has, in its central portion in the length direction L, a thickness of, for example, about 10 μm or greater and about 100 μm or less in the height direction T, which connects the first main surface 12a and the second main surface 12b.

The second base electrode layer 32b on a portion of the first main surface 12a and a portion of the second main surface 12b preferably has, in its central portion in the length direction L, a thickness of, for example, about 10 μm or greater and about 100 μm or less in the height direction T, which connects the first main surface 12a and the second main surface 12b.

The first base electrode layer 32a on a portion of the first side surface 12c and a portion of the second side surface 12d preferably has, in its central portion in the length direction L, a thickness of, for example, about 10 μm or greater and about 100 μm or less in the width direction W.

The second base electrode layer 32b on a portion of the first side surface 12c and a portion of the second side surface 12d preferably has, in its central portion in the length direction L, a thickness of, for example, about 10 μm or greater and about 100 μm or less in the width direction W.

In the case of the conductive resin layer, the conductive resin layer includes a first conductive resin layer and a second conductive resin layer.

The first conductive resin layer is provided as the first base electrode layer 32a and covers another layer such as a baked layer, for example. The second conductive resin layer is provided as the second base electrode layer 32b and covers another layer such as a baked layer, for example.

Specifically, it is preferable that the first conductive resin layer as the first base electrode layer 32a and the second conductive resin layer as the second base electrode layer 32b are respectively disposed on the other layers such as the baked layers respectively formed on the first end surface 12e and the second end surface 12f, and further extend over portions of the other layers such as the baked layers disposed on the first main surface 12a, the second main surface 12b, the first side surface 12c, and the second side surface 12d. Nevertheless, the first conductive resin layer and the second conductive resin layer may be disposed on only the other layers such as the baked layers on the first end surface 12e and the second end surface 12f.

Each of the first conductive resin layer and the second conductive resin layer preferably has a thickness of, for example, about 10 μm or greater and about 200 μm or less.

The first conductive resin layer and the second conductive resin layer include a thermosetting resin and a metal component, for example.

Due to including the thermosetting resin, the first conductive resin layer and the second conductive resin layer are more flexible than the base electrode layer 32 that is defined by, for example, a plated film or a fired product of a conductive paste. For this reason, the conductive resin layers define and function as buffer layers, making it possible to prevent cracks from forming in the multilayer ceramic capacitor 10 even when a physical impact or an impact due to a thermal cycle is applied to the multilayer ceramic capacitor 10.

Specific examples of the thermosetting resin include various known thermosetting resins such as an epoxy resin, a phenol resin, a urethane resin, a silicone resin, a polyimide resin, or the like. Among them, the epoxy resin excellent in heat resistance, moisture resistance, adhesion, etc., is one of the suitable resins.

The first conductive resin layer and the second conductive resin layer preferably include a curing agent together with the thermosetting resin. In a case of using an epoxy resin as the base resin, various known compounds such as, for example, a phenol-based compound, an amine-based compound, an acid anhydride-based compound, an imidazole-based compound, or the like can be used as the curing agent for the epoxy resin.

As the metal included in the first conductive resin layer and the second conductive resin layer, for example, Ag, Cu, or an alloy thereof can be used. Alternatively, for example, a metal powder including a surface coated with Ag can be used. In the case of using a metal powder having a surface coated with Ag, for example, a Ag-coated Cu or Ni powder is preferred.

Alternatively, for example, Cu subjected to an antioxidant treatment can be used. The reason for using the Ag-coated metal is that an inexpensive metal can be employed as the base material while the characteristics of Ag are maintained.

The first conductive resin layer and the second conductive resin layer preferably include, for example, the metal in an amount of about 35 vol % or greater and about 75 vol % or less with respect to the total volume of the conductive resin.

The metal included in the first conductive resin layer and the second conductive resin layer may have any shape without particular limitation. The conductive filler may have a spherical shape, a flat shape, or the like.

The metal included in the first conductive resin layer and the second conductive resin layer may have any average particle diameter without particular limitation. The conductive filler may have an average particle diameter of, for example, about 0.3 μm or greater and about 10 μm or less.

The metal included in the first conductive resin layer and the second conductive resin layer is mainly responsible for the electrical conductivity of the conductive resin layers. Specifically, the conductive filler particles in contact with each other provide conduction paths in the conductive resin layer.

The metal included in the first conductive resin layer and the second conductive resin layer may have a spherical shape, a flat shape, or the like, but it is preferable to use a mixture of a spherical metal powder and a flat metal powder.

Each of the first conductive resin layer and the second conductive resin layer may include a resin layer including conductive particles and a thermosetting resin. In the case of forming the resin layer, the first and second conductive resin layers may be formed directly on the multilayer body without forming the baked layers.

### Plating Layer

Next, the plating layer 34 disposed on the base electrode layer 32 will be described with reference to FIG. 4. The plating layer 34 includes a first upper plating layer 34a and a second upper plating layer 34b. The plating layer 34 covers the conductive resin layer.

Specifically, it is preferable that the plating layer 34 is disposed over the conductive resin layer on the first end surface 12e and the conductive resin layer on the second end surface 12f, and extends to the conductive resin layers on the first main surface 12a, the second main surface 12b, the first side surface 12c, and the second side surface 12d. However, the plating layer 34 may be disposed over only the conductive resin layers on the first end surface 12e and the second end surface 12f.

The plating layer 34 includes, for example, at least one of Cu, Ni, Ag, Pd, a Ag—Pd alloy, Au, or the like.

The plating layer 34 may include a plurality of layers. A two-layer structure including Ni plating and Sn plating, for example, is preferred. Providing the plating layer 34 of Ni plating that covers the conductive resin layer makes it possible to prevent the base electrode layer 32 and the conductive resin layer from being eroded by solder used for mounting the multilayer ceramic capacitor 10. Providing a Sn plating layer on the Ni plating layer makes it possible to improve wettability of solder used for mounting the multilayer ceramic capacitor 10, thereby facilitating the mounting.

The Ni plating layer preferably has a thickness of, for example, about 1 μm or greater and about 15 μm or less. The Sn plating layer preferably has a thickness of, for example, about 1 μm or greater and about 15 μm or less.

### Multilayer Ceramic Capacitor

As illustrated in FIG. 1, for the multilayer ceramic capacitor 10 including the multilayer body 12, the first external electrode 30a, and the second external electrode 30b, a dimension in the length direction L is defined as an L dimension, a dimension in the height direction T is defined as a T dimension, and a dimension in the width direction W is defined as a W dimension. The dimensions of the multilayer ceramic capacitor 10 are, for example, preferably as follows: the L dimension in the length direction L is about 0.2 mm or greater and about 10.0 mm or less, the W dimension in the width direction W is about 0.1 mm or greater and about 10.0 mm or less, and the T dimension in the height direction T is about 0.1 mm or greater and about 5.0 mm or less.

### 2. Method of Manufacturing Multilayer Ceramic Capacitor

Next, an example of a method of manufacturing the multilayer ceramic capacitor will be described.
(1) Dielectric sheets and a conductive paste for forming internal electrode layers are prepared. The dielectric sheets and the conductive paste include a binder and a solvent. A known binder and a known solvent can be used.
(2) Next, the conductive paste for forming internal electrode layers is printed in a predetermined pattern on the dielectric sheets by, for example, screen printing, gravure printing, or the like so that dielectric sheets including thereon a first internal electrode pattern corresponding to the first internal electrode layer and dielectric sheets including thereon a second internal electrode pattern corresponding to the second internal electrode layer are prepared. In addition, dielectric sheets including no internal electrode pattern printed thereon are prepared as dielectric sheets for forming outer layer portions.
(3) A predetermined number of dielectric sheets for forming outer layer portions, which are devoid of the internal electrode pattern, are laminated to form a portion to define and function as the second outer layer portion. On this portion, the dielectric sheets including the first internal electrode pattern and the dielectric sheets including the second internal electrode pattern are sequentially laminated to form a portion to define and function as the inner layer portion.
(4) Furthermore, a predetermined number of dielectric sheets, which are devoid of the internal electrode pattern, are laminated on the internal electrode pattern provided with identification information and corresponding to the internal electrode layer to be located on the outermost surface of the inner layer portion, thus forming a portion to serve as the first outer layer portion. In this way, a multilayer sheet is prepared.
(5) The multilayer sheet is pressed in the lamination direction by, for example, isostatic pressing, thus preparing a multilayer block.
(6) The multilayer block is cut into a predetermined size so that multilayer chips are produced. In this step, the corner portions and ridge portions of the multilayer chips may be rounded by, for example, barrel polishing or the like. The foregoing is the steps of preparing the multilayer chips.
(7) The multilayer chips are fired so that the multilayer bodies 12 are produced. The firing temperature is, for example, preferably about 900° C. or higher and about 1400° C. or lower although it depends on the ceramic and the materials of the internal electrode layers 16.
(8) A conductive paste for forming the first base electrode layer 32a including a metal component and a glass component and a conductive paste for forming the second base electrode layer 32b including a metal component and a glass component are prepared.
(9) The conductive paste for forming the first base electrode layer 32a and the conductive paste for forming the second base electrode layer 32b are respectively applied to the first end surface 12e and the second end surface 12f, which are the opposite end surfaces of the multilayer body 12, thus forming the first base electrode layer 32a and the second base electrode layer 32b. For example, the conductive pastes are applied to the opposite end surfaces of the multilayer body 12 by a method such as dipping or screen printing, and thereafter, the applied conductive pastes are baked to form the first base electrode layer 32a and the second base electrode layer 32b. The temperature of this baking process is, for example, preferably about 700° C. or higher and about 900° C. or lower.
(10) The features and advantageous effects of example embodiments of the present invention can be achieved by controlling the sintering temperature and the thicknesses of the base electrode layers (on the end surface and the side surface).
(11) If necessary, plating is provided on the surfaces of the first base electrode layer 32a and the second base electrode layer 32b to form plating layers. In the present example embodiment, two plating layers are formed on the surface of each of the first base electrode layer 32a and the second base electrode layer 32b. Specifically, for example, a Ni plating layer is formed on each of the first base electrode layer 32a and the second base electrode layer 32b, and a Sn plating layer is formed on each Ni plating layer. The Ni plating layer and the Sn plating layer are sequentially formed by barrel plating, for example.

In the above-described method, the multilayer ceramic capacitor 10 according to the example embodiment illustrated in FIG. 1 is manufactured.

In the multilayer ceramic capacitor 10 manufactured in the above-described example method, the voids in the first outer layer portion-side base electrode layer 32o1 and the voids in the second outer layer portion-side base electrode layer 32o2 have a lower space occupancy percentage than the voids in the first inner layer portion-side base electrode layer 32i1, the glass in the first outer layer portion-side base electrode layer 32o1 and the glass in the second outer layer portion-side base electrode layer 32o2 have a lower space occupancy percentage than the glass in the first inner layer portion-side base electrode layer 32i1, the voids in the third outer layer portion-side base electrode layer 32o3 and the voids in the fourth outer layer portion-side base electrode layer 32o4 have a lower space occupancy percentage than the voids in the second inner layer portion-side base electrode layer 32i2, and the glass in the third outer layer portion-side base electrode layer 32o3 and the glass in the fourth outer layer portion-side base electrode layer 32o4 have a lower space occupancy percentage than the glass in the second inner layer portion-side base electrode layer 32i2. By virtue of this feature the film density of the portion of the external electrodes on the outer layer portions is increased, thus making it possible to ensure moisture resistance.

### 3 Experimental Examples

In order to determine the advantageous effects of the above-described multilayer ceramic capacitor according to the present example embodiment, as multilayer ceramic capacitors experimental samples were prepared by the above-described manufacturing method, and subjected to an experiment. In the experiment, values of moisture resistance (IR) were measured to determine whether moisture resistance of the multilayer ceramic capacitors was ensured or not.

### (1) Specifications of Multilayer Ceramic Capacitors Prepared as Examples

Multilayer ceramic capacitors as samples of Examples 1 to 4 were prepared by the manufacturing method according to the above-described example embodiment.
Dimensions (design value) of the multilayer ceramic capacitor: L×W×T=about 1.8 mm×about 0.8 mm×about 0.8 mm
Ceramic material: BaTiO₃
Capacitance: about 4.7 μF
Rated voltage: about 10 V
Material of internal electrode layers: Ni
Structure of external electrodes: conductive metal (Cu) and glass component
Film thickness of the external electrode on central portion of the end surface: about 65 μm

### (2) Specifications of a Multilayer Ceramic Capacitor Prepared as Comparative Example

A multilayer ceramic capacitor as a sample of Comparative Example 1 was prepared by the manufacturing method according to the above-described example embodiment. The sample of Comparative Example 1 was prepared so that the space occupancy percentage of the voids in the base electrode layer, the space occupancy percentage of the glass in the base electrode layer, and the space occupancy percentage of the glass in the outer layer portion-side base electrode layer were changed. The rest of the specifications were the same or substantially the same as those of the samples of Examples.

### (3) Moisture Resistance Test Method

Test conditions: about 85° C.
Relative humidity: about 85%
Applied voltage: about 10 V
Test time: about 1000 hours

### (4) Method of Evaluating Moisture Resistance

In a case where the value of moisture resistance (IR) was equal to or greater than about 107 MΩ, the moisture resistance was evaluated as “good” (indicated by circle symbol “o”), and in a case where the value of moisture resistance (IR) was less than about 107 MΩ, the moisture resistance was evaluated as “fail” (indicated by cross symbol “x”). Here, IR refers to the insulation resistance of the multilayer ceramic capacitor.

### (5) Method of Measuring Voids and Glass

The space occupancy percentage of the voids and the space occupancy percentage of the glass were determined under the following conditions. Obtaining SEM Images and EDX Analysis Images
Equipment: Tabletop SEM (TM3030PLUS)
Conditions: backscattered electron image (with electrification reduction)/standard (15 kV)/the image was brightened to a degree at which the voids were recognized, and contrast was enhanced. Magnification of image:
about 1200 times (interior of the base electrode layer)
about 1000 times (surface of the base electrode layer)
EDX analysis (mapping: portions corresponding to Si were shown in white)
Surface of the base electrode layer
Magnification: about 1000 times
Resolution: about 512×416 pixels (width of image about 150.6 μm)
Interior of the base electrode layer
Magnification: about 1200 times
Resolution: about 512×416 pixels (width of image about 125.5 μm)
Scan Speed=Slow 3
Observation location: Cross section B of an LT plane (interior of the base electrode layer)

### Measurement of Voids

Image-J was used to binarize the image of the base electrode layer into the voids and other regions. The binarized data was used to measure the area ratio of the voids so that the space occupancy percentage of the voids was calculated.

### Measurement of Glass

EDX analysis was performed on the range of the obtained SEM image. Si elements were mapped, and the image was saved. The obtained image was binarized using Image-J, and the area ratio of Si was measured so that the space occupancy percentage of the glass was calculated.

### (6) Results

Table 1 shows the space occupancy percentage of the voids in the base electrode layer (the outer layer portion-side base electrode layer and the inner layer portion-side base electrode layer), the space occupancy percentage of the glass in the base electrode layer (the outer layer portion-side base electrode layer and the inner layer portion-side base electrode layer), the values of moisture resistance (IR), and the results of evaluation of the moisture resistance of the samples of the multilayer ceramic capacitors of Examples 1 to 4 and Comparative Example 1.

TABLE 1

| | Space Occupancy Percentage of Voice | | Space Occupancy Percentage of Glass | | | |
|---|---|---|---|---|---|---|
| | in Base Electrode Layer [%] | | in Base Electrode Layer [%] | | | |
| | Outer Layer Portion- | Inner Layer Portion- | Outer Layer Portion- | Inner Layer Portion- | Moisture | Evaluation of |
| | Side Base | Side Base | Side Base | Side Base | Resistance (IR) | Moisture |
| | Electrode Layer | Electrode Layer | Electrode Layer | Electrode Layer | (MΩ) | Resistance |
| Example 1 | 2.4 | [symbol] | 4.8 | [symbol] | [symbol] | ∘ |
| Example 2 | [symbol] | [symbol] | 7.4 | [symbol] | [symbol] | ∘ |
| Example 3 | [symbol] | [symbol] | [symbol] | [symbol] | [symbol] | ∘ |
| Example 4 | [symbol] | [symbol] | [symbol] | [symbol] | [symbol] | ∘ |
| Comparative | [symbol] | [symbol] | [symbol] | [symbol] | [symbol] | x |
| Example 1 | | | | | | |

[symbol]

indicates data missing or illegible when filed

Table 1 shows that since the samples of Examples 1 to 4 each had a value of moisture resistance (IR) of about 107 MΩ or greater, the moisture resistance of them are evaluated as “good” (indicated by circle symbol “∘”). With respect to the space occupancy percentage of the voids in the base electrode layer, in each of the samples of Examples 1 to 4, the space occupancy percentage of the voids in the outer layer portion-side base electrode layer is lower than that of the voids in the inner layer portion-side base electrode layer. With respect to the space occupancy percentage of the glass in the base electrode layer, in each of the samples of Examples 1 to 4, the space occupancy percentage of the glass in the outer layer portion-side base electrode layer is lower than that of the glass in the inner layer portion-side base electrode layer.

On the other hand, since the sample of Comparative Example 1 had a value of moisture resistance (IR) less than about 107 MΩ, the moisture resistance thereof was evaluated as “fail” (indicated by cross symbol “x”). With respect to the space occupancy percentage of the voids in the base electrode layer, in the sample of Comparative Example 1, the space occupancy percentage of the voids in the outer layer portion-side base electrode layer is higher than that of the voids in the inner layer portion-side base electrode layer. With respect to the space occupancy percentage of the glass in the base electrode layer, in the sample of Comparative Example 1, the space occupancy percentage of the glass in the outer layer portion-side base electrode layer is higher than that of the glass in the inner layer portion-side base electrode layer.

Table 2 shows the space occupancy percentage of the glass in the outer layer portion-side base electrode layer (the end-surface-side region and the main-surface-side region), values of moisture resistance (IR), and the results of evaluation of moisture resistance of the samples of the multilayer ceramic capacitors of Examples 1 to 3 and Comparative Example 1.

TABLE 2

| | Space Occupancy Percentage of | | | |
|---|---|---|---|---|
| | Glass In Outer Layer Portion- | | Moisture | Evaluation |
| | Side Base Electrode Layer [%] | | Resistance | of |
| | End-Surface- | Main-Surface- | (IR) | Moisture |
| | Side Region | Side Region | [MΩ] | Resistance |
| Example 1 | 9.0 | 5.3 | 125.9 | ∘ |
| Example 2 | 12.2 | 6.4 | 398.1 | ∘ |
| Example 3 | 17.2 | 8.0 | 1258.9 | ∘ |
| Comparative | 3.5 | 12.5 | 0.8 | x |
| Example 1 | | | | |

Table 2 shows that since the samples of Examples 1 to 3 had a value of moisture resistance (IR) of about 107 MΩ or greater, the moisture resistance of them are evaluated as “good” (indicated by circle symbol “∘”). With respect to the space occupancy percentage of the glass in the outer layer portion-side base electrode layer, in each of the samples of Examples 1 to 3, the space occupancy percentage of the glass in the main-surface-side region is lower than that of the glass in the end-surface-side region.

On the other hand, since the sample of Comparative Example 1 had a value of moisture resistance (IR) less than about 107 MΩ, the moisture resistance thereof was evaluated as “fail” (indicated by cross symbol “x”). With respect to the space occupancy percentage of the glass in the outer layer portion-side base electrode layer, in the sample of Comparative Example 1, the space occupancy percentage of the glass in the main-surface-side region is higher than that of the glass in the end-surface-side region.

The above results indicate that the multilayer ceramic capacitors according to example embodiments of the present invention can ensure moisture resistance by virtue of the feature in which the outer layer portion-side base electrode layers have a low space occupancy percentage of the voids, a low space occupancy percentage glass, of and a high film density; specifically due the feature in which the voids in the first outer layer portion-side base electrode layer and the voids in the second outer layer portion-side base electrode layer have a lower space occupancy percentage than the voids in the first inner layer portion-side base electrode layer, the glass in the first outer layer portion-side base electrode layer and the glass in the second outer layer portion-side base electrode layer have a lower space occupancy percentage than the glass in the first inner layer portion-side base electrode layer, the voids in the third outer layer portion-side base electrode layers and the voids in the fourth outer layer portion-side base electrode layer have a lower space occupancy percentage than the voids in the second inner layer portion-side base electrode layer, the glass in the third outer layer portion-side base electrode layer and the glass in the fourth outer layer portion-side base electrode layer have a lower space occupancy percentage than the glass in the second inner layer portion-side base electrode layer, the space occupancy percentage of the voids in the first inner layer portion-side base electrode layer is about 11% or greater and about 16% or less, the space occupancy percentage of the voids in the first outer layer portion-side base electrode layer and the space occupancy percentage of the voids in second outer layer portion-side base electrode layer are each about 2% or greater and about 10% or less, the space occupancy percentage of the voids in the second inner layer portion-side base electrode layer is about 11% or greater and about 16% or less, the space occupancy percentage of the voids in the third outer layer portion-side base electrode layer and the space occupancy percentage of the voids in the fourth outer layer portion-side base electrode layer are each about 2% or greater and about 10% or less, the space occupancy percentage of the glass in the first inner layer portion-side base electrode layer is about 8% or greater and about 11% or less, the space occupancy percentage of the glass in the first outer layer portion-side base electrode layer and the space occupancy percentage of the glass in the second outer layer portion-side base electrode layer are each about 4.5% or greater and about 7.5% or less, the space occupancy percentage of the glass in the second inner layer portion-side base electrode layer is about 8% or greater and about 11% or less, and the space occupancy percentage of the glass in the third outer layer portion-side base electrode layer and the space occupancy percentage of the glass in the fourth outer layer portion-side base electrode layer are each about 4.5% or greater and about 7.5% or less.

The above results indicate that a multilayer ceramic capacitors according to example embodiments of the present invention can ensure moisture resistance by virtue of the feature in which the outer layer portion-side base electrode layers have a further increased film density; specifically due to the feature in which the glass in the first main-surface-side region has a lower space occupancy percentage than the glass in the first end-surface-side region, the glass in the second main-surface-side region has a lower space occupancy percentage than the glass in the second end-surface-side region, the glass in the third main-surface-side region has a lower space occupancy percentage than the glass in the third end-surface-side region, the glass in the fourth main-surface-side region has a lower space occupancy percentage than the glass in the fourth end-surface-side region, the space occupancy percentage of the glass in the first main-surface-side region and the space occupancy percentage of the glass in the third main-surface-side region are each about 5% or greater and about 8% or less, the space occupancy percentage of the glass in the first end-surface-side region and the space occupancy percentage of the glass in the second end-surface-side region are each about 9% or greater and about 18% or less, the space occupancy percentage of the glass in the second main-surface-side region and the space occupancy percentage of the glass in the fourth main-surface-side region are each about 5% or greater and about 8% or less, and the space occupancy percentage of the glass in the third end-surface-side region and the space occupancy percentage of the glass in the fourth end-surface-side region are each about 9% or greater and about 18% or less.

In the foregoing, example embodiments of the present invention have been described. The present invention is not limited to the example embodiments described above.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers and a plurality of internal electrode layers that are laminated, a first main surface and a second main surface opposed to each other in a height direction, a first side surface and a second side surface opposed to each other in a width direction that is orthogonal or substantially orthogonal to the height direction, a first end surface and a second end surface opposed to each other in a length direction that is orthogonal or substantially orthogonal to the height direction and the width direction, an inner layer portion in which the plurality of dielectric layers and the plurality of internal electrode layers are alternately laminated, and outer layer portions sandwiching the inner layer portion from a side of the first main surface and a side of the second main surface;
a first external electrode including a first base electrode layer on the first end surface, and a plating layer on the first base electrode layer; and
a second external electrode including a second base electrode layer on the second end surface, and a plating layer on the second base electrode layer; wherein
the first and second base electrode layers include metal, glass, and voids;
the inner layer portion includes:
a first inner layer portion adjacent to the first end surface; and
a second inner layer portion adjacent to the second end surface;
the outer layer portions include:
a first outer layer portion adjacent to the first main surface and the first end surface;
a second outer layer portion adjacent to the second main surface and the first end surface;
a third outer layer portion adjacent to the first main surface and the second end surface; and
a fourth outer layer portion adjacent to the second main surface and the second end surface;
the first base electrode layer includes:
a first inner layer portion-side base electrode layer on the first inner layer portion;
a first outer layer portion-side base electrode layer on the first outer layer portion; and
a second outer layer portion-side base electrode layer on the second outer layer portion;
the second base electrode layer includes:
a second inner layer portion-side base electrode layer on the second inner layer portion;
a third outer layer portion-side base electrode layer on the third outer layer portion; and
a fourth outer layer portion-side base electrode layer on the fourth outer layer portion;
the voids in the first outer layer portion-side base electrode layer and the voids in the second outer layer portion-side base electrode layer have a lower space occupancy percentage than the voids in the first inner layer portion-side base electrode layer;
the glass in the first outer layer portion-side base electrode layer and the glass in the second outer layer portion-side base electrode layer have a lower space occupancy percentage than the glass in the first inner layer portion-side base electrode layer;
the voids in the third outer layer portion-side base electrode layer and the voids in the fourth outer layer portion-side base electrode layer have a lower space occupancy percentage than the voids in the second inner layer portion-side base electrode layer;
the glass in the third outer layer portion-side base electrode layer and the glass in the fourth outer layer portion-side base electrode layer have a lower space occupancy percentage than the glass in the second inner layer portion-side base electrode layer;
the space occupancy percentage of the voids in the first inner layer portion-side base electrode layer is about 11% or greater and about 16% or less;
the space occupancy percentage of the voids in the first outer layer portion-side base electrode layer and the space occupancy percentage of the voids in the second outer layer portion-side base electrode layer are each about 2% or greater and about 10% or less;
the space occupancy percentage of the voids in the second inner layer portion-side base electrode layer is about 11% or greater and about 16% or less;
the space occupancy percentage of the voids in the third outer layer portion-side base electrode layer and the space occupancy percentage of the voids in the fourth outer layer portion-side base electrode layer are each about 2% or greater and about 10% or less;
the space occupancy percentage of the glass in the first inner layer portion-side base electrode layer is about 8% or greater and about 11% or less;
the space occupancy percentage of the glass in the first outer layer portion-side base electrode layer and the space occupancy percentage of the glass in the second outer layer portion-side base electrode layer are each about 4.5% or greater and about 7.5% or less;
the space occupancy percentage of the glass in the second inner layer portion-side base electrode layer is about 8% or greater and about 11% or less; and
the space occupancy percentage of the glass in the third outer layer portion-side base electrode layer and the space occupancy percentage of the glass in the fourth outer layer portion-side base electrode layer are each about 4.5% or greater and about 7.5% or less.

2. The multilayer ceramic capacitor according to claim 1, wherein each of the plurality of dielectric layers includes BaTiO₃, CaTiO₃, SrTiO₃, or CaZrO₃ as a main component.

3. The multilayer ceramic capacitor according to claim 1, wherein each of the plurality of dielectric layers includes a Mn compound, a Fe compound, a Cr compound, a Co compound, or a Ni compound as a subcomponent.

4. The multilayer ceramic capacitor according to claim 1, wherein each of the plurality of dielectric layers has a thickness of about 0.5 μm or greater and about 10 μm or less.

5. The multilayer ceramic capacitor according to claim 1, wherein each of the first and second base electrode layers includes at least one of Cu, Ni, Ag, Pd, a Ag—Pd alloy, or Au.

6. The multilayer ceramic capacitor according to claim 1, wherein a maximum thickness of each of the first and second base electrode layers is about 10 μm or greater and about 150 μm or less.

7. The multilayer ceramic capacitor according to claim 1, wherein the first base electrode layer includes a first conductive resin layer, and the second base electrode layer includes a second conductive resin layer.

8. The multilayer ceramic capacitor according to claim 7, wherein a thickness of each of the first and second conductive resin layers is about 10 μm or greater and about 200 μm or less.

9. The multilayer ceramic capacitor according to claim 7, wherein each of the first and second conductive resin layers includes a thermosetting resin.

10. The multilayer ceramic capacitor according to claim 9, wherein the thermosetting resin includes an epoxy resin, a phenol resin, a urethane resin, a silicone resin, or a polyimide resin.

11. A multilayer ceramic capacitor comprising:
a multilayer body including a plurality of dielectric layers and a plurality of internal electrode layers that are laminated, a first main surface and a second main surface opposed to each other in a height direction, a first side surface and a second side surface opposed to each other in a width direction that is orthogonal or substantially orthogonal to the height direction, a first end surface and a second end surface opposed to each other in a length direction that is orthogonal or substantially orthogonal to the height direction and the width direction, an inner layer portion in which the plurality of dielectric layers and the plurality of internal electrode layers are alternately laminated, and outer layer portions sandwiching the inner layer portion from a side of the first main surface and a side of the second main surface;
a first external electrode including a first base electrode layer on the first end surface, and a plating layer on the first base electrode layer; and
a second external electrode including a second base electrode layer on the second end surface, and a plating layer on the second base electrode layer; wherein
the first and second base electrode layers include metal, glass, and voids;
the inner layer portion includes:
a first inner layer portion adjacent to the first end surface; and
a second inner layer portion adjacent to the second end surface;
the outer layer portions include:
a first outer layer portion adjacent to the first main surface and the first end surface;
a second outer layer portion adjacent to the second main surface and the first end surface;
a third outer layer portion adjacent to the first main surface and the second end surface; and
a fourth outer layer portion adjacent to the second main surface and the second end surface;
the first base electrode layer includes:
a first inner layer portion-side base electrode layer on the first inner layer portion;
a first outer layer portion-side base electrode layer on the first outer layer portion; and
a second outer layer portion-side base electrode layer on the second outer layer portion;
the second base electrode layer includes:
a second inner layer portion-side base electrode layer on the second inner layer portion;
a third outer layer portion-side base electrode layer on the third outer layer portion; and
a fourth outer layer portion-side base electrode layer on the fourth outer layer portion;
the first outer layer portion-side base electrode layer includes a first end-surface-side region adjacent to the first end surface, and a first main-surface-side region adjacent to the first main surface;
the second outer layer portion-side base electrode layer includes a second end-surface-side region adjacent to the first end surface, and a second main-surface-side region adjacent to the second main surface;
the third outer layer portion-side base electrode layer includes a third end-surface-side region adjacent to the second end surface, and a third main-surface-side region adjacent to the first main surface;
the fourth outer layer portion-side base electrode layer includes a fourth end-surface-side region adjacent to the second end surface, and a fourth main-surface-side region adjacent to the second main surface;
the glass in the first main-surface-side region has a lower space occupancy percentage than the glass in the first end-surface-side region;
the glass in the second main-surface-side region has a lower space occupancy percentage than the glass in the second end-surface-side region;
the glass in the third main-surface-side region has a lower space occupancy percentage than the glass in the third end-surface-side region;
the glass in the fourth main-surface-side region has a lower space occupancy percentage than the glass in the fourth end-surface-side region;
the space occupancy percentage of the glass in the first main-surface-side region and the space occupancy percentage of the glass in the third main-surface-side region are each about 5% or greater and about 8% or less;
the space occupancy percentage of the glass in the first end-surface-side region and the space occupancy percentage of the glass in the second end-surface-side region are each about 9% or greater and about 18% or less;
the space occupancy percentage of the glass in the second main-surface-side region and the space occupancy percentage of the glass in the fourth main-surface-side region are each about 5% or greater and about 8% or less; and
the space occupancy percentage of the glass in the third end-surface-side region and the space occupancy percentage of the glass in the fourth end-surface-side region are each about 9% or greater and about 18% or less.

12. The multilayer ceramic capacitor according to claim 11, wherein each of the plurality of dielectric layers includes BaTiO₃, CaTiO₃, SrTiO₃, or CaZrO₃ as a main component.

13. The multilayer ceramic capacitor according to claim 11, wherein each of the plurality of dielectric layers includes a Mn compound, a Fe compound, a Cr compound, a Co compound, or a Ni compound as a subcomponent.

14. The multilayer ceramic capacitor according to claim 11, wherein each of the plurality of dielectric layers has a thickness of about 0.5 μm or greater and about 10 μm or less.

15. The multilayer ceramic capacitor according to claim 11, wherein each of the first and second base electrode layers includes at least one of Cu, Ni, Ag, Pd, a Ag—Pd alloy, or Au.

16. The multilayer ceramic capacitor according to claim 11, wherein a maximum thickness of each of the first and second base electrode layers is about 10 μm or greater and about 150 μm or less.

17. The multilayer ceramic capacitor according to claim 11, wherein the first base electrode layer includes a first conductive resin layer, and the second base electrode layer includes a second conductive resin layer.

18. The multilayer ceramic capacitor according to claim 17, wherein a thickness of each of the first and second conductive resin layers is about 10 μm or greater and about 200 μm or less.

19. The multilayer ceramic capacitor according to claim 17, wherein each of the first and second conductive resin layers includes a thermosetting resin.

20. The multilayer ceramic capacitor according to claim 19, wherein the thermosetting resin includes an epoxy resin, a phenol resin, a urethane resin, a silicone resin, or a polyimide resin.
